(19) United States
(12) Patent Application Publication
(10) Pub. No.: US 2013/0290788 A1
(43) Pub. Date: Oct. 31, 2013

(54) MINIMUM OUTPUT CURRENT TEST APPARATUS

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: YUN BAI, Shenzhen (CN); SONG-LIN TONG, Shenzhen (CN)

(73) Assignees: Hon Hai Precision Industry Co., Ltd., New Taipei (TW); Hong Fu Jin Precision Industry (ShenZhen) Co., Ltd., Shenzhen (CN)

(21) Appl. No.: 13/863,345

(22) Filed: Apr. 15, 2013

(30) Foreign Application Priority Data
Apr. 26, 2012 (CN) 201210125893.3

(51) Int. Cl. G06F 11/22

(52) U.S. Cl. CPC G06F 11/2284
USPC 714/37

(57) ABSTRACT

An apparatus tests currents from a plurality of power ports of a power supply unit (PSU), to test minimum value of the currents. The apparatus includes a connector, a controller, a time sequence detection circuit, and a plurality of load circuits. The time sequence detection circuit detects a start time-sequence of the ports of the PSU. Each load circuit is electronically connected to a power port of the PSU. The controller activates and applies each load circuit to a power port of the PSU according the start time-sequence of the ports of the PSU, controls a current-draw of each load circuit until the PSU works in a normal state, and displays the established minimum output current when the PSU works in the normal state.

### BACKGROUND

1. Technical Field

The exemplary disclosure generally relates to test apparatuses, and particularly to a minimum output current test apparatus.

2. Description of Related Art

A power supply unit (PSU) used in a motherboard system needs to supply a minimum output current. When a power-on button of the motherboard is triggered, and an actual current drawn from the PSU is lower than the minimum output current, the PSU will stop working and cut off power output altogether, which will cause the motherboard system to malfunction.

A reference value of the minimum output current which must be drawn from the PSU can be obtained from a PSU manufacturer. However, a circuit designer has a need to know the practical and actual value of the minimum output current.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 shows a block diagram of an exemplary embodiment of an apparatus for testing minimum output current draws from power ports of a power supply unit (PSU).

FIG. 2 shows a circuit diagram of an exemplary embodiment of a connector of the apparatus and the PSU shown in FIG. 1.

FIG. 3 shows a circuit diagram of an exemplary embodiment of a time sequence detection circuit and a controller of the apparatus shown in FIG. 1.

FIG. 4 shows a circuit diagram of an exemplary embodiment of a load circuit of the apparatus shown in FIG. 1.

FIG. 5 shows a circuit diagram of an exemplary embodiment of a current detection circuit of the apparatus shown in FIG. 1.

### DETAILED DESCRIPTION

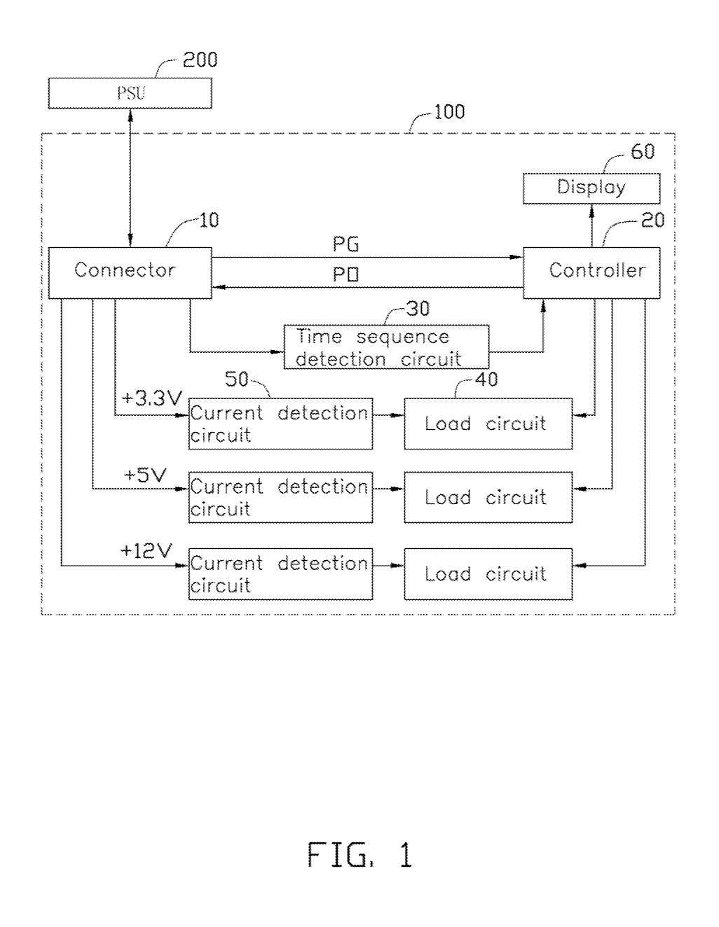

FIG. 1 shows a block diagram of an exemplary embodiment of a apparatus 100 for testing current drawing from power ports, and establishing minimum values of the currents of the power ports, such as +5V port, +3.3V port, and +12V port for example, of a power supply unit (PSU) 200. Each power port outputs a certain power level. For example, the +5V port outputs a +5V power; and the +3.3V port outputs a +3.3V power. The PSU 200 further includes a standby power port for outputting +5V standby power +5VSB. The apparatus 100 includes a connector 10, a controller 20, a time sequence detection circuit 30, a plurality of load circuits 40, a plurality of current detection circuits 50, and a display 60.

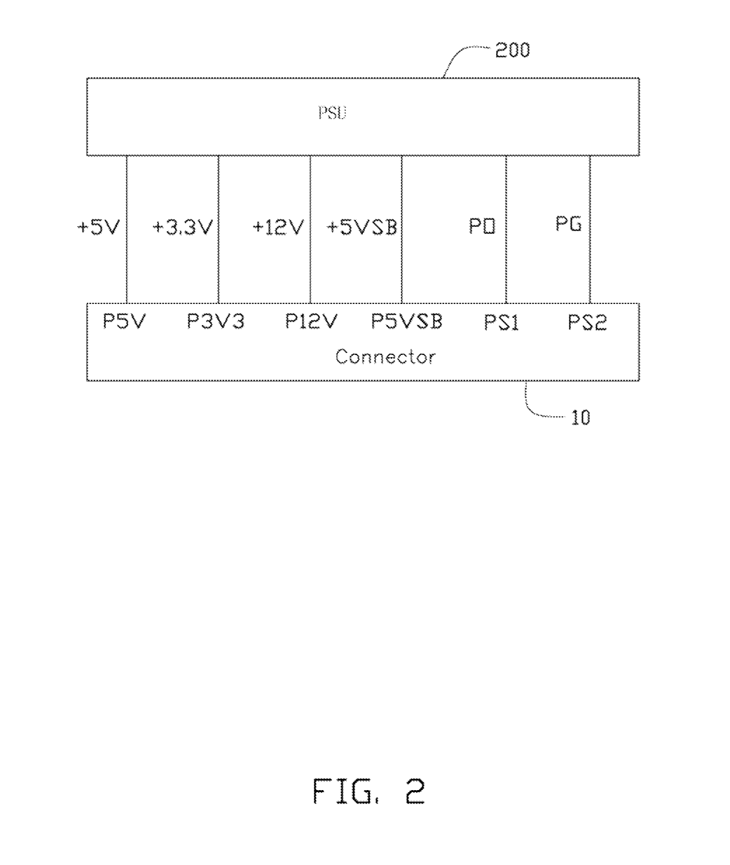

FIG. 2 shows a circuit diagram of an exemplary embodiment of the connector 10 of the apparatus 100 and the PSU 200 shown in FIG. 1. The connector 10 is electronically connected to the power ports of the PSU 10. In particular, the connector 10 includes a +5V power pin PSV, a +3.3V power pin P3V3, a +12V power pin P12V, a +5V standby power pin P5VSB, a power-on pin PS1, and a power-good pin PS2. Each power pin connects to a power port of the PSU 200, to receive a certain power level. Both the power-on pin PS1 and the power-good pin PS2 are electronically connected to the controller 20 and the PSU 200. In use, the PSU 200 starts to output different electrical powers in sequence according to a start time-sequence when the controller 20 outputs a power-on signal PO to the PSU 200 via the power-on pin PS1 of the connector 10. After each power output of the PSU 200 is started and in a steady state, the PSU 200 outputs a power-good signal PG to the controller 20 via the power-good pin PS2 of the connector 10.

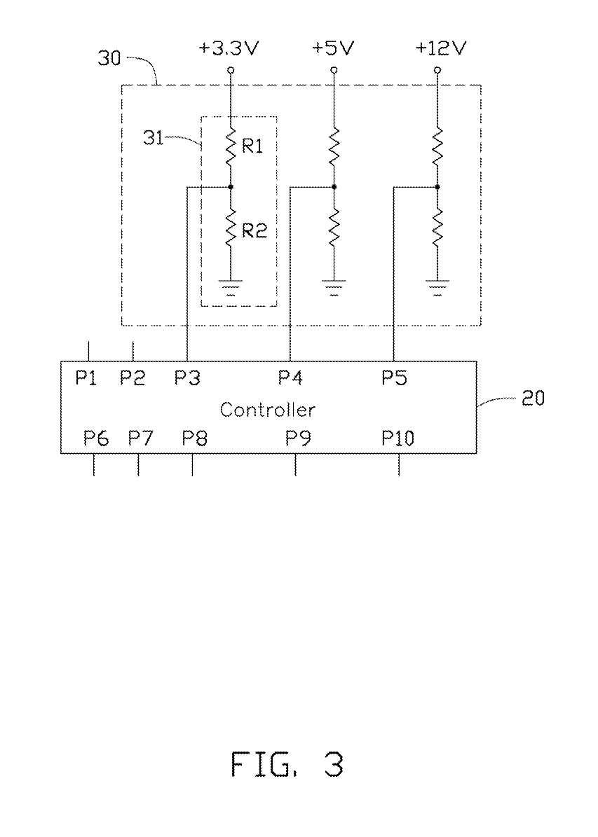

FIG. 3 shows a circuit diagram of an exemplary embodiment of the controller 20 and the time sequence detection circuit 30 of the apparatus 100 shown in FIG. 1. The controller 20 includes ten pins P1-P10. The pin P1 is electronically connected to the power-on pin PS1 of the connector 10, and the pin P2 is electronically connected to the power-good pin PS2 of the connector 10 (the circuitry connections are not shown).

The time sequence detection circuit 30 cooperates with the controller 20 in detecting the start time-sequence of the power ports of the PSU 200. The time sequence detection circuit 30 includes three voltage division circuits 31. Each voltage division circuit 31 includes a first resistor R1 and a second resistor R2 connected in series between one power port and ground. A node between the first and second resistors R1 and R2 of each voltage division circuit 31 is electronically connected to one of the pins P3-P5 of the controller 20. For example, the first and second resistors R1 and R2 of one of the voltage division circuits 31 are electronically connected between the +3.3V power port and ground, and a node between the first and second resistors R1 and R2 is electronically connected to the pin P4 of the controller 20. Each voltage division circuit 31 is capable of matching voltage levels between a power port of the PSU 200 and the controller 20. For example, when the +12V power is started and in a steady state, the voltage circuit 13 which is connected to it divides the +12V power, and a divided voltage on the node between the first and second resistors R1 and R2 is a high voltage level (e.g. logic 1) which can be distinguished as such by the controller 20.

The controller 20 scans voltage levels of the pins P3-P5 to determine the start time-sequence of the power ports of PSU 200, and activates the load circuits 40 to connect and impose a load to the power port corresponding to the started power according to the start time-sequence, thereby simulating a motherboard (not shown) load which must be powered by the PSU 200.

In the exemplary embodiment, the apparatus 100 includes three load circuits 40 (see FIG. 1), where each load circuit 40 presents a load to a power port of the PSU 200. For example, one of the load circuits 40 presents a load to the +5V power port of the PSU 200; another one of the load circuits 40 presents a load to the +3.3V power port of the PSU 200. The controller 20 controls a current-draw of each load circuit 40 until the PSU works in a normal state.

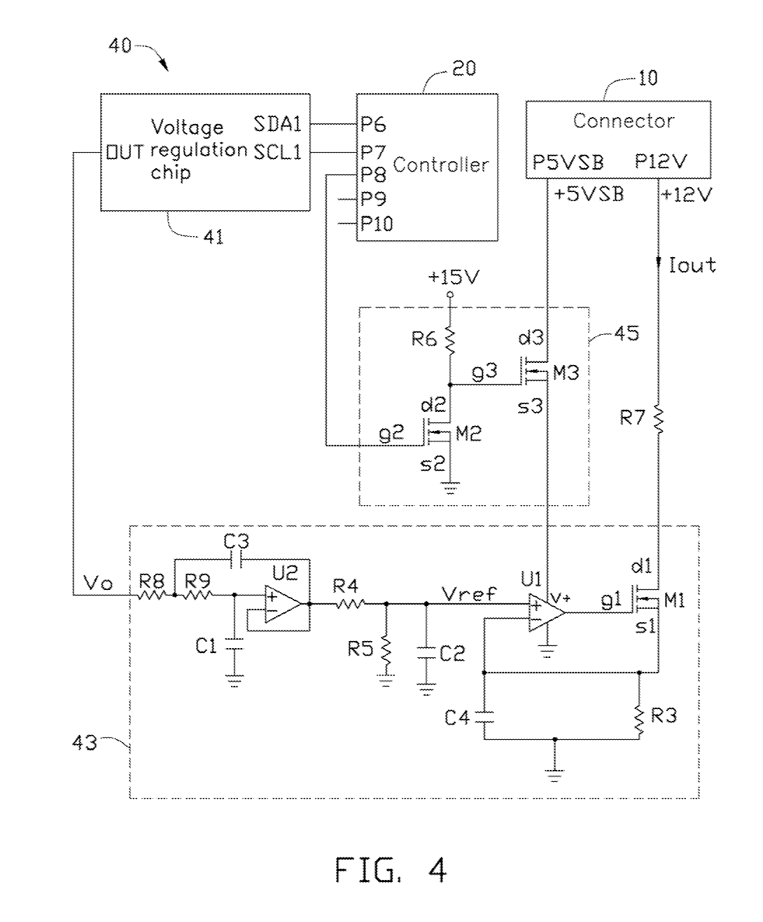

FIG. 4 shows a circuit diagram of an exemplary embodiment of a load circuit 40 of the apparatus 100 shown in FIG. 1. Each load circuit 40 includes a voltage regulation chip 41, a current regulation circuit 43, and a sequence control circuit 45. The voltage regulation chip 41 outputs an output voltage Vo to the current regulation circuit 43, and regulates the output voltage Vo under the control of the controller 20. In particular, the voltage regulation chip 41 includes a DATA pin SDA1, a clock pin SCL1, and an output pin OUT. The DATA pin SDA1 is electronically connected to the pin P6 of the controller 20; the clock pin SCL1 is electronically connected to the pin P7 of the controller; and the output pin OUT outputs voltage Vo to the current regulation circuit 43. The voltage regulation chip 41 receives control signals from the controller 20 via the DATA pin SDA1 and the clock pin SCL1, and regulates the output voltage Vo in response to the control signals.

The current regulation circuit 43 includes a first amplifier U1, a second amplifier U2, a source resistor R3, a first voltage division resistor R4, a second voltage division resistor R5, two resistors R8-R9, a first metal-oxide-semiconductor field-effect transistor (MOSFET) M1, three filtering capacitors C1-C3, and a bypass capacitor C4. A non-inverting input terminal of the second amplifier U2 is electronically connected to the output pin OUT of the voltage regulation chip 41 via the resistors R8 and R9; an output terminal of the second amplifier U2 is electronically connected to an inverting input terminal of the second amplifier U2 and a non-inverting input terminal of the first amplifier U1. An inverting input terminal of the first amplifier U1 is electronically connected to a source s1 of the first MOSFET M1; an output terminal of the first amplifier U1 is electronically connected to a gate g1 of the first MOSFET M1. A drain d1 of the first MOSFET M1 is electronically connected to a power pin of the connector 10, to receive power from the PSU 200. In the exemplary embodiment, the +12V power port of the PSU 200 is used here as the only example to illustrate the operation of each current regulation circuit 43. The drain d1 of the first MOSFET M1 is electronically connected to the +12V power pin P12V of the connector 10, to receive +12V from the +12V power port of the PSU 200. The source resistor R3 is electronically connected between the source s1 of the first MOSFET M1 and ground. The bypass capacitor C4 is electronically connected between the source s1 of the first MOSFET M1 and ground. The first voltage division resistor R4 is electronically connected between the output terminal of the second amplifier U2 and the non-inverting input terminal of the first amplifier U1; and a node between the first voltage division resistor R4 and the non-inverting input terminal of the first amplifier U1 is grounded via the second voltage division resistor R5. The non-inverting input terminal of the first amplifier U1 is grounded via the filtering capacitor C2. The non-inverting input terminal of the second amplifier U2 is also grounded via the filtering capacitor C1. A node between the two resistors R8 and R9 is electronically connected to the output terminal of the second amplifier U2 via the filtering capacitor C3.

In use, the +12V power port of the PSU 200 makes electrical current available to the drain d1 of the first MOSFET M1 via the connector 10, thus the first MOSFET M1 can simulate a load taking current from the +12V power port of the PSU 200. The first and second amplifiers U1 and U2, and the first and second voltage division resistors R4 and R5 cooperate to form a biasing circuit. The biasing circuit outputs a driving voltage to the gate g1 of the first MOSFET M1, and regulates the driving voltage output to the gate g1 according to the output voltage Vo, thereby regulating current flowing to the drain d1 of the first MOSFET M1, that is the current lout being output from the +12V power port of the PSU 200. In detail, the resistors R8 and R9, the filtering capacitors C1 and C3, and the second amplifier U2 cooperate to serve as a low-pass filter for filtering the output voltage Vo. The first and second voltage division resistors R4 and R5 divide the filtered output voltage Vo, and output a divided voltage, that is, a reference voltage Vref to the non-inverting input terminal of the first amplifier U1. The first amplifier U1 outputs a voltage to the gate g1 of the first MOSFET M1 to drive the first MOSFET M1 to take current from the +12V power port of the PSU 200. When the output voltage Vo changes, the reference voltage Vref and the driving voltage being output to the gate g1 of the MOSFET M1 change accordingly, thereby regulating the current taken by the drain d1 of the first MOSFET M1. In other words, the load applied to the +12V power of the PSU 200 can be precisely regulated. It is to be understood that the first and second amplifiers U1 and U2 can be integrated into a single integrated chip, to form a dual operational amplifier.

The sequence control circuit 45 of each load circuit 40 includes a second MOSFET M2 and a third MOSFET M3. A gate g2 of the second MOSFET M2 is electronically connected to the pin P8 of the controller 20; a source s2 of the second MOSFET M2 is grounded; and a drain d2 of the second MOSFET M2 is electronically connected to a gate g3 of the third MOSFET M3. A drain d3 of the third MOSFET M3 is electronically connected to the +5V standby power pin P5VSB to receive the +5V standby power offered by the PSU 200, and a source s3 of the third MOSFET M3 is electronically connected to a power terminal V+ of the first amplifier U1. A node between the drain d2 of the second MOSFET M2 and the gate g3 of the third MOSFET M3 is electronically connected to a +15V power supply via a pull-up resistor R6. When the controller 20 receives the power-good signal PG from the PSU 200, the controller 20 outputs a low level voltage signal (e.g. logic 0) to the sequence control circuit 45 of each load circuit 40 in sequence according to the start time-sequence, thereby activating each first MOSFET M1 to present a load to a power port of the PSU 200.

For example, the PSU 200 outputs +5V power, +3.3V power, and +12V power following a start time-sequence whereby the +12V power is output first, then the +5V power is output, and the +3.3V power is output last. The controller 20 outputs a low level voltage signal via the pin P8 to switch off the second MOSFET M2 of the sequence control circuit 45 corresponding to the +12V power, so the third MOSFET M3 is switched on, the first amplifier U1 is powered on by the +15V power supply, and the first MOSFET M1 is switched on to take current from the +12V power port of the PSU 200, thereby the load circuit 40 applies an electrical loading to the +12V power port.

Meanwhile, the load circuit 40 connected to the +5V power port of the PSU 200 and the load circuit 40 connected to the +3.3V power port of the PSU 200 do not operate at this time. Next, the controller 20 activates the load circuit 40 connected to the +5V power port of the PSU 200 via the connector 10 to present a load to the +5V power port, and then activates the load circuit 40 connected to the +3.3V power port of the PSU 200 via the connector 10 to present a loading to the +3.3V power port, according to the start time-sequence. After all of the power ports of the PSU 200 have been loaded, the controller 20 regulates currents taken from the power ports of the PSU 200 by regulating output voltages Vo of the voltage regulation chips 41. Since the controller 20 controls the load circuits 40 to apply loads to the powers ports of the PSU 200 according to the start time-sequence, which simulates an actual motherboard and a plurality of loads taking electrical current from the PSU 200.

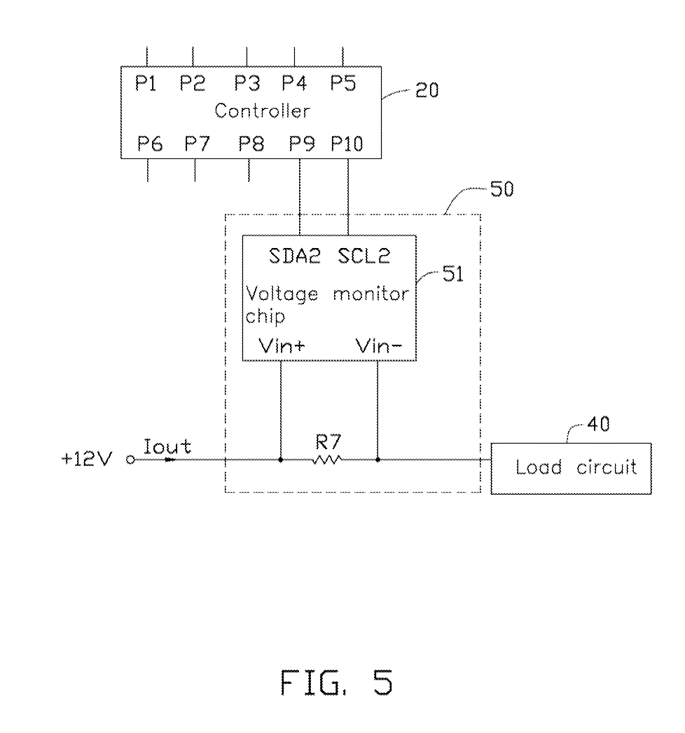

FIG. 5 shows a circuit diagram of an exemplary embodiment of the current detection circuit 50 of the apparatus 100 shown in FIG. 1. Each current detection circuit 50 cooperates with the controller 20 in detecting the output current Iout of a power port of the PSU 200 (see FIG. 1). Each current detection circuit 50 includes a current detection resistor R7, and a voltage monitor chip 51. The +12V power port of the PSU 200 is used as the only example to illustrate operation of each current detection circuit 50.

The current detection resistor R7 is electronically connected between the +12V power pin of the connector 10 and the drain d1 of the first MOSFET M1 (see FIG. 4). The voltage monitor chip 51 includes a first input pin Vin+, a second input pin Vin−, a data pin SDA2, and a clock pin SCL2. The data pin SDA2 is electronically connected to the pin P9 of the controller 20, and the clock pin SCL2 is electronically connected to the pin P10 of the controller 20. The data pin SDA2 and the clock pin SCL2 enable data communication between the voltage monitor chip 51 and the controller 20. The current detection resistor R7 is further electronically connected between the first and second input pins Vin+ and Vin−. The voltage monitor chip 51 detects a voltage across the current detection resistor R7 via the first and second input pins Vin+ and Vin−, transforms the detected voltage to a digital value, and outputs the digital value to the controller 20. The controller 20 calculates the output current Iout of the +12V power of the PSU 200 according to the digital value and a resistance of the current detection resistor R7, and displays the calculated output current Iout on the display 60.

The working process of the apparatus 100 can be carried out by, but is not limited to, the following steps. The controller 20 outputs the power-on signal PO to the PSU 200 via the connector 10, to enable the PSU 200 to start outputting power to the power ports. Simultaneously, the time sequence detection circuit 30 cooperates with the controller 20 in detecting the start time-sequence of the power ports of the PSU 200. After the controller 20 receives the power-good signal PG from the PSU 200, the controller 20 controls each load circuit 40 to present a load to a power port of the PSU 200 according to the start time-sequence, and controls each load circuit 40 to gradually increase the current taken from the power port of PSU 200 until the PSU 200 works in a normal state. In particular, the controller 20 controls the voltage regulation chip 41 of each load circuit 40 to output a suitable voltage Vo which enables a minimum output of current from the PSU 200, such as 0.1 mA, for example. Then, the controller 20 increases the currents taken from two of the three ports, +12V port , the +5V port, and the +3V port (such as the +5V port and the +3V port) by an preset increment (of 0.1 mA, for example), and holds the current drawn from the remaining port (such as the +12V port) to be unvarying. If the PSU 200 goes into a shut down state even if the current drains on the +5V and +3V ports have been increased to a preset maximum value (such as 2.0 mA for example), the controller 20 controls the load circuit 40 for the +12V port to increase the current draw to 0.2mA, and controls the other two load circuits 40 to increase the current draws from the minimum value to the maximum value by the increments again, until the PSU 200 reaches a normal state. At this time, the current being output by each power port of the PSU 200 is the minimum output current of that power port. The controller 20 cooperates with the current detection circuit 50 in detecting the output current of each power port of the PSU 200, and displays the established minimum output current of each power port of the PSU 200 on the display 60.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An apparatus, comprising:
a connector electronically connected to a plurality of power ports of a power supply unit (PSU);
a controller;
a time sequence detection circuit electronically connected to the controller and the connector, the time sequence detection circuit cooperating with the controller in detecting a start time-sequence of the power ports of the PSU; and
a plurality of load circuits, each load circuit electronically connected to a power port of the PSU via the connector;
wherein the controller is electronically connected to each load circuit, the controller activates each load circuit to a power port of the PSU according the start time-sequence of the power ports of the PSU, controls a current-draw of each load circuit until the PSU works in a normal state, and displays a value of an output current drawing from each power port when the PSU works in the normal state.

2. The apparatus of claim 1, wherein the connector is electronically connected to the controller, the controller outputs a power on signal to the PSU via the connector to activate the PSU, and the PSU starts the plurality of power ports in sequence according to the start time-sequence; when each power port of the PSU is started and in a steady state, the PSU outputs a power-good signal to the controller via the connector, to control the controller to activate the plurality of load circuits.

3. The apparatus of claim 1, wherein the time sequence detection circuit comprises a plurality of voltage division circuits, each voltage division circuit is electronically connected to one power port of the PSU; each voltage division circuit comprises a first resistor and a second resistor connected in series between the power port of the PSU and ground; a node between the first and second resistors of each voltage division circuit is electronically connected to the controller; the controller detects a voltage level of the node between the first and second resistors of each voltage division circuit to determine the start time-sequence of the power ports of the PSU.

4. The apparatus of claim 2, wherein each load circuit comprises a voltage regulation chip, a biasing circuit, and a first metal-oxide-semiconductor field-effect transistor (MOSFET), the voltage regulation chip is electronically connected to the controller, the biasing circuit is electronically connected between an output of the voltage regulation chip and an input of the first MOSFET, the first MOSFET is electronically connected to corresponding power port via the connector; the voltage regulation chip outputs an output voltage to the biasing circuit, and regulates the output voltage under the control of the controller; the biasing circuit regulates a driving voltage output to the first MOSFET according to the output voltage, thereby regulating an output current drawn from the power port of the PSU output to the first MOSFET.

5. The apparatus of claim 4, wherein the biasing circuit comprises a first amplifier and a source resistor, a non-inverting input terminal of the first amplifier is electronically connected to the output of the voltage regulation chip, an inverting input terminal of the first amplifier is electronically connected to a source of the first MOSFET, and an output terminal of the first amplifier is electronically connected to a gate of the first MOSFET; a drain of the first MOSFET is electronically connected to the corresponding power port of the PSU via the connector, and a source of the first MOSFET is grounded via the source resistor; the first amplifier outputs the driving voltage to drive the first MOSFET to obtain the output current from the corresponding power port of the PSU.

6. The apparatus of claim 5, wherein the biasing circuit further comprises a second amplifier, a third resistor, a fourth resistor, a first filtering capacitor, and a second filtering capacitors, the third and fourth resistors are electronically connected between an non-inverting input terminal of the second amplifier and the output of the voltage regulation chip; a node between the third and fourth resistors are electronically connected to an output terminal of the second amplifier via second filtering capacitor; an inverting input terminal and the output terminal of the second amplifier are connected, and the output terminal of the second amplifier is further electronically connected to the non-inverting input terminal of the first amplifier; the non-inverting input of the second amplifier is grounded via the first filtering capacitor.

7. The apparatus of claim 6, wherein the biasing circuit further comprises a first voltage division resistor and a second voltage division resistor, the first voltage division resistor is electronically connected between the output terminal of the second amplifier and the non-inverting input terminal of the first amplifier, a node between the first voltage division resistor and the non-inverting input terminal of the first amplifier is grounded via the second voltage division resistor.

8. The apparatus of claim 5, wherein each load circuit further comprises a sequence control circuit electronically connected to the biasing circuit and the controller; the controller controls the sequence control circuit of each load circuit to activate the biasing circuit according to the start time-sequence of the powers of the PSU.

9. The apparatus of claim 8, wherein the sequence control circuit of each load circuit comprises a first power supply, a second power supply, a second MOSFET, a third MOSFET, and a pull-up resistor; a gate of the second MOSFET is electronically connected to the controller, a source of the second MOSFET is grounded, and a drain of the second MOSFET is electronically connected to a gate of the third MOSFET; a drain of the third MOSFET is electronically connected to the first power supply , and a source of the third MOSFET is electronically connected to a power terminal of the first amplifier;
a node between the drain of the second MOSFET and the gate of the third MOSFET is electronically connected to the second power supply via the pull-up resistor.

10. The apparatus of claim 9, wherein the first power supply is a +5V standby power output from the PSU, and the second power supply is a +15V power supply.

11. The apparatus of claim 5, further comprising a plurality of current detection circuits, wherein the plurality of current detection circuits are electronically connected to the controller; each current detection circuit is electronically connected to one power port of the PSU via the connector, each current detection circuit cooperates with the controller in detecting the output current of the corresponding power port of the PSU.

12. The apparatus of claim 11, wherein each current detection circuit comprises a current detection resistor electronically connected between the corresponding power port of the PSU and the load circuit, and a voltage monitor chip electronically connected to two terminals of the current detection resistor; the voltage monitor chip detects a voltage across the current detection resistor, and converts the voltage across the current detection resistor to digital value, the controller receives the digital value and calculates the output current of each power port of the PSU according the digital value and the resistance of the current detection resistor.
